(19) United States
(12) Patent Application Publication
(10) Pub. No.: US 2004/0061682 A1
(43) Pub. Date: Apr. 1, 2004

(54) Interface for generating process and co-ordination inputs

(76) Inventor: Stefan Landfried, Painten (DE)

Correspondence Address: BARNES & THORNBURG, 11 SOUTH MERIDIAN, INDIANAPOLIS, IN, 46204

(21) Appl. No.: 10/466,013

(22) PCT Filed: Jan. 10, 2002
(86) PCT No.: PCT/EP02/00169

(30) Foreign Application Priority Data
Jan. 10, 2001 (DE) 10100845.7

(51) Int. Cl. G09G 5/08

(52) U.S. Cl. 345/163

(57) ABSTRACT

The invention relates to an interface for generating process and coordination inputs, in the form of a computer mouse having an at least two-part housing comprised of a base part and an upper part that are detachably connected to each other, as well as, optionally, a position recording device for generating position signals for recording the position of the housing.

Placed in the upper part is a user interface with at least one input element, on the outside of the upper part for generating input signals, as well as a transmission device mounted on or in the base part and connected to the input element and optionally with the position recording device for the transmission of input signals received from the input element or of position signals received from the position recording device, whereby in or on the base part, a first connection element that is connected to the transmission device, and in or on the upper part, a second second [sic] connection element that is connected to the input element, are arranged in such a way that the two connection elements form an electrical, detachable connection when the base part and the upper part are connected to each other.

The present invention relates to an interface for generating process and coordination inputs as it is already commonly in use in the form of a computer mouse. Such interfaces are used for controlling computers in all areas of application.

Input technologies according to the state of the art are usually based on the transmission of word commands by means of a keyboard and/or position commands by means of transmission of x/y/z coordinates from input devices such as computer mice or trackballs. Up to now, these interfaces have also been satisfactorily answering the demands for accuracy of motion detection and the transmission of process commands. However, professional users are quickly meeting the limits of accuracy, rapidity of command transmission and ergonomics of these input devices. In addition, it is disadvantageous that these interfaces are usually uniform for all kinds of applications that run on computers. This means that the widest variety of programs, such as, for example, CAD applications, internet browsers, text processing, etc., have to be carried out with a standardized interface.

Computer mice are well-known in the state of the art. They usually exhibit a two-part housing in which the input and transmission electronics are housed. The two housing parts are usually screwed to each other. DE 299 06 631 U1 discloses a computer mouse in which the two parts of the housing are connected to each other by means of a locking mechanism. This makes it easy to connect the two parts together, and in particular, to remove the upper part of the housing by means of a snap opening in order to service, repair or replace the components located inside the mouse. In this regard, the upper shell of this housing serves only to cover the complete input, evaluation and transmission electronics located on the lower part of the housing.

In the printed publication Research Diclosure [sic] No. 421, May 1999, p. 692 XP000888757 “Multicasing Computer Pointing Device”, a computer mouse comprised of an upper part and a lower part is disclosed. The upper part includes the part of the mouse that is in contact with the user. The lower part includes wires, the mouse ball, rotation sensors and click sensors of the mouse buttons. The upper part can vary for the various applications, and can be connected with the lower part, which is configured in the same way, independently of the various applications.

Printed publication PCT/EP 02/00169 discloses a mouse on which a processor-based computer, which includes a keyboard, a display and a data memory, can be placed.

The task of the present invention is to make available an interface for generating process and coordination inputs, in the form of a computer mouse, that can be configured both application-specific as well as user-specific.

This task is solved by means of the interface according to patent claim 1 and the uses according to patent claims 22 and 23. Advantageous further developments of the interface according to the invention are given in the particular dependent claims.

The computer mouse according to the invention exhibits a two-part housing as in the state of the art. According to the invention, however, all of the elements that are invariant in all interfaces, the transmission device in particular, are now located in the lower part or base part of the mouse, while the upper part of the housing exhibits a user interface. The two housing parts are detachably connected to each other, whereby provided in both the base part and the upper part of the housing are connecting elements, which match each other and which are placed in corresponding locations, and over which electrical signals can be exchanged between the upper part and the base part. Such connecting elements can be plugs and sockets of an electrical plug-and-socket connection.

The user interface itself can exhibit individual keys, complete keyboards, trackballs, 3D sticks, wheels or other possible input devices.

What is now advantageous about the interface according to the invention is the fact that the input functions can be changed through a simple exchange of the upper part of the housing, while as the base part, the technically complex and cost-intensive part of the interface always remains the same and only has to be acquired once. This interface can thus be exchanged between various applications in the shortest possible time. For example, upper parts with two or three keys can be used in the usual way for text processing systems. For CAD applications, there are upper parts with a total of 16 keys, while for games and such, position-detection elements such as 3D sticks, wheels or similar things can be integrated into the interface of the upper part. It is also possible to connect to the base part upper parts of the housing that are adapted to the individual user. Thus, for example, smaller upper shells, possibly with special lower parts, can be used for children than for adults. This means, for example, that the given user brings along the upper shell that has been individually tailored for him, and, for example, attaches it to the base unit. The variably configurable computer mouse can thus be easily adapted to various applications and the level of knowledge of the user. For example, it is sometimes advisable to limit the number of keys for beginners in the use of a program, while professional users might want to work with all of the options, and thus with an upper part with many keys. The interface according to the invention thus makes possible, in a cost-effective way, user interfaces that can be as complex as desired, thus making process-specific commands executable with minimized idle time.

The areas of application of an interface of this type lie not only in the private sector of computer use, but also in the generation of CAD/CAM drawings, in DTP/creative productions, and basically, in all EDP application areas in which high accuracy, high efficiency, frequent transmission of commands, exact xyz coordinate control, longevity and modular adaptability of the input device are required.

By way of summary, it can be said that the core of the invention is the separation of the function unit. interface into the base part and the upper part, whereby the base part (“base”) serves as the base station for the widest possible variety of upper parts (“shape”) in order to undertake the transmission of signals to the computer.

In this regard, the transmission of signals can take place either directly to a computer cable, via wire, or even wirelessly, as is already known in the state of the art. It is especially advantageous if the interface exhibits a coil by means of which the data can be sent wirelessly to a digitizing tablet (“plate”). Information from the computer can thus be received by the computer via the digitizing tablet. In addition, the coil is also well-suited for recording the position of the interface on the digitizing tablet. Consequently, an especially favorable variant is the combination of the digitizing technology that is already commercially available, and an interface as is being suggested here.

In the case of a digitizing tablet as described above, the tablet serves as the base unit for recording the control signals that are transmitted from the base part of the interface when there is input or a change in coordinates. The tablet is connected to an EDP system by means of cable plug-and-socket connections, and then provides the interface with the basis for working on it the same way it would on a mouse pad. In this regard, position data from the interface are recorded by the electromagnetic grid and transmitted, along with the signals from the pressed keys on the upper part of the interface, to the tablet. The latter then forwards this information to the computer for further evaluation.

This results not only in a ergonomic design and relaxed work, but also in the most accurate position detection. Through suitable assignment of the keys on the upper part of the interface, which can be defined in a program-specific way by downstream software in the computer, it is possible in particular to pass commands and coordinates to the computer system in a very short time. In the first trials in the field of CAD drawing generation, speed increases in the range of 100 to 400% were achieved after only a very short familiarization period.

In addition, the interface can advantageously exhibit an electronic memory or a plug-in space for a mobile electronic memory, i.e., a flashcard, for example. By doing that, the widest possible variety of information can be temporarily stored in the interface, such as, for example, GUIDs (“Global Unique Identifiers”), passwords, LOGIN data, etc. Data from the computer can also be transmitted into this memory, such as user-specific menu assignments and similar things. In that case, the mouse can serve as temporary storage that the user can take with him from one computer to another. This has the advantage that the user immediately has his own menu assignments available on every computer. Moreover, he no longer needs to make a note of passwords and LOGIN data, since he always has them along with his interface. Thus, the interface according to the invention can also be used to control access to computers, certain software or, for example, access to the internet. In an appropriate way, the interface also detects the user software and then uses the associated menu assignments of its input means in adaptation to the software.

The interface can also be configured in such a way that access to a computer is possible only in the presence of the interface. In that case, the user can always carry his computer mouse with him so that access to his computer is no longer possible in his absence. The tablet (“plate”) detects the presence and absence of the computer mouse, and automatically switches the computer system to blocked operation or enables it again upon connection of the uniquely defined computer mouse.

In addition, link administration for access to the internet can be stored in a memory of this type. To further personalize the mouse, it is also possible to provide a memory or an interface for a memory, for example, a memory card from which music files in compressed form can be exchangeably played and stored by the user. To do this, a specific upper part (shape) can be made available to the user, on which a display with control units such as keys, detents, controllers and similar things can be provided for controlling the memory or playing back the music files. A connection for stereo headphones is then provided in the base part of the computer mouse.

Thus made available to the user is an audio system, an MP3 player, for example, that can be used along with normal use of the mouse. For that purpose, the latching mechanism for locking together the upper part and the base part of the mouse, and the positioning functionalities as a cursor exist in parallel with the playback operation.

Several examples of interfaces according to the invention are described below.

Shown are:

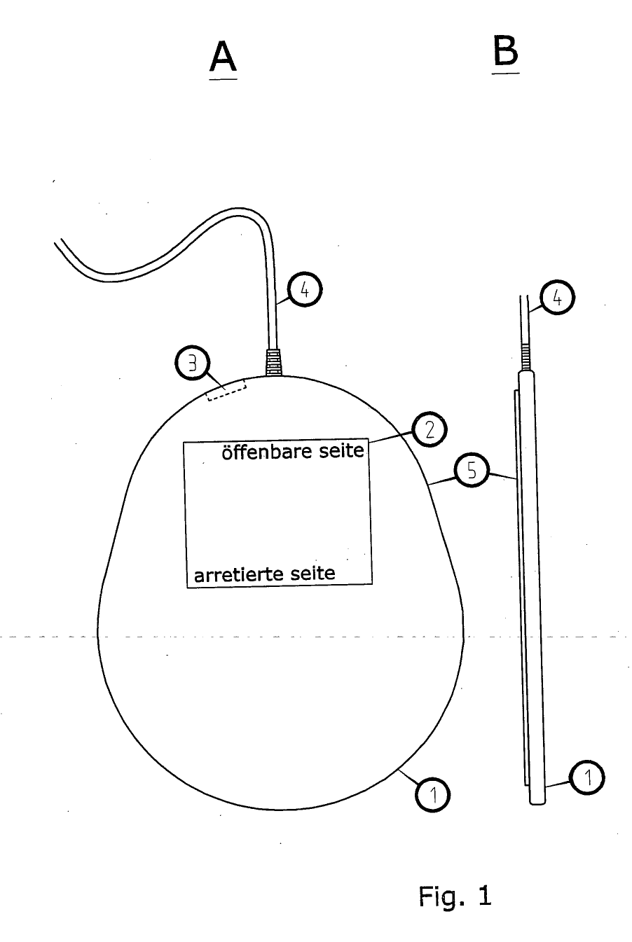

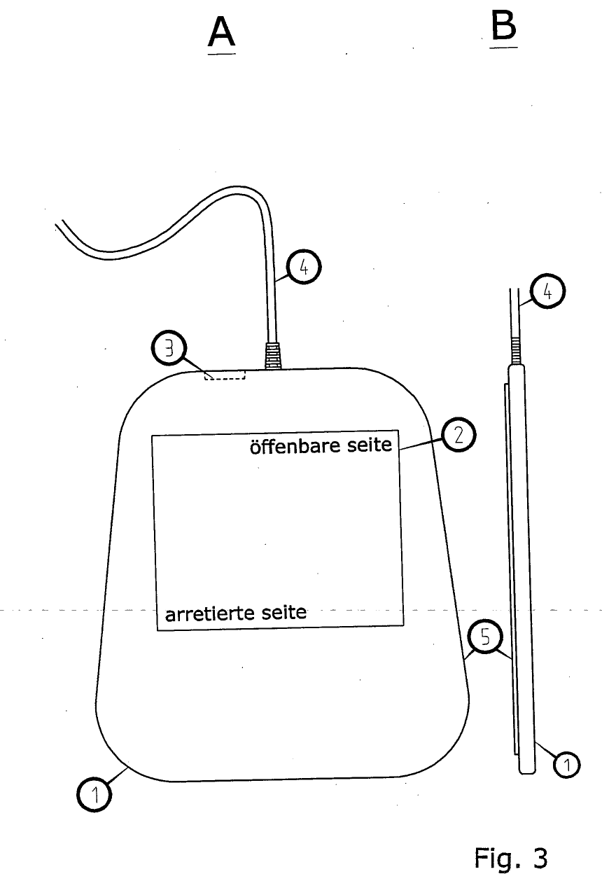

FIGS. 1 through 4 conventional digitizing tablet;

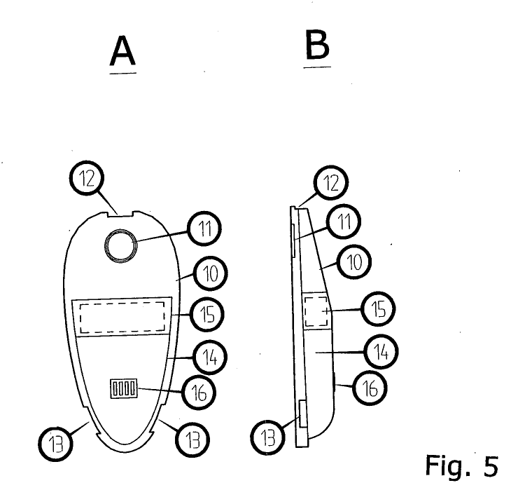

FIG. 5 a lower part of an interface according to the invention;

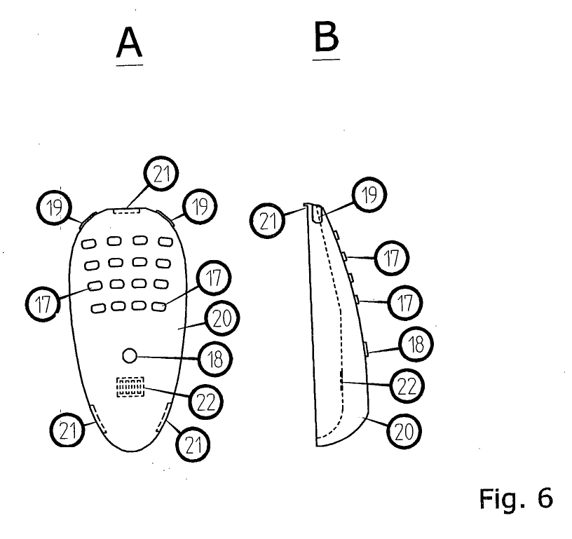

FIGS. 6 through 10 various upper parts of interfaces according to the invention;

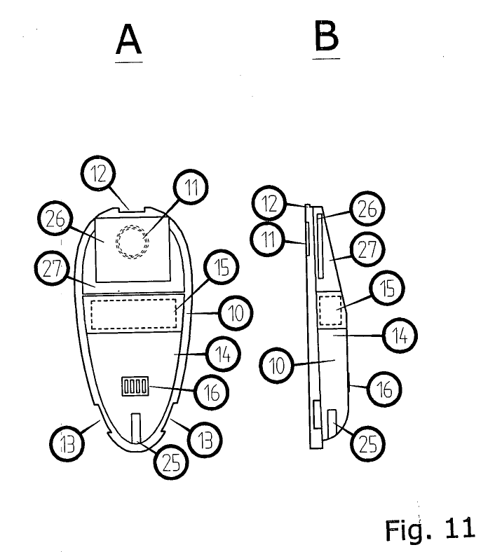

FIG. 11 another lower part of an interface according to the invention;

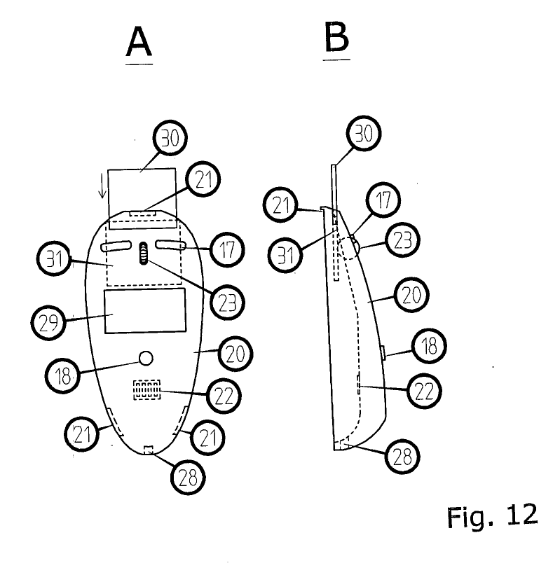

FIG. 12 the upper part associated with FIG. 11;

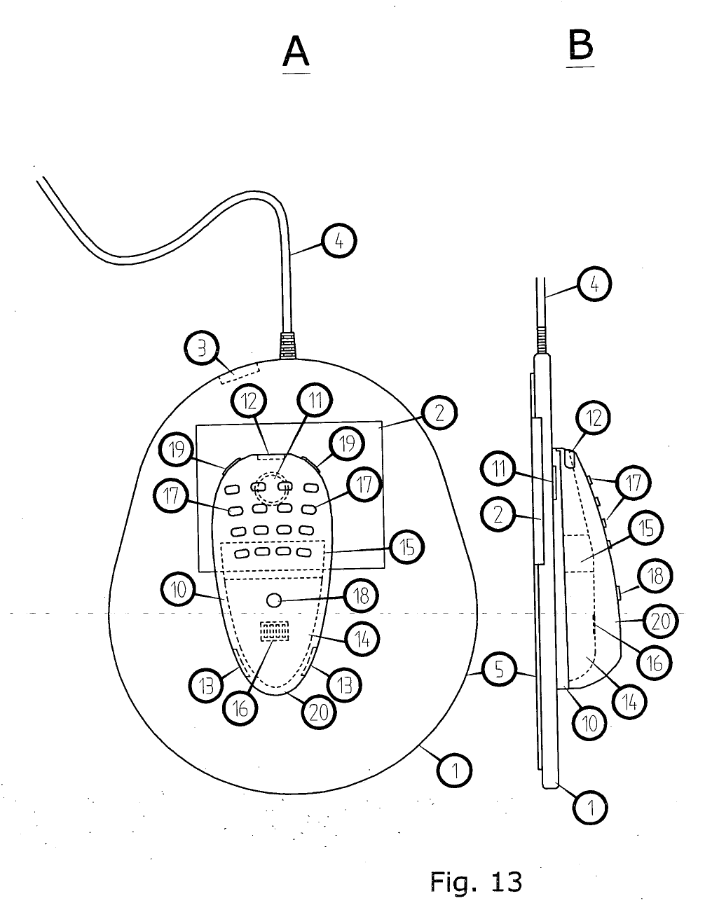

FIG. 13 a digitizing tablet with an interface according to the invention;

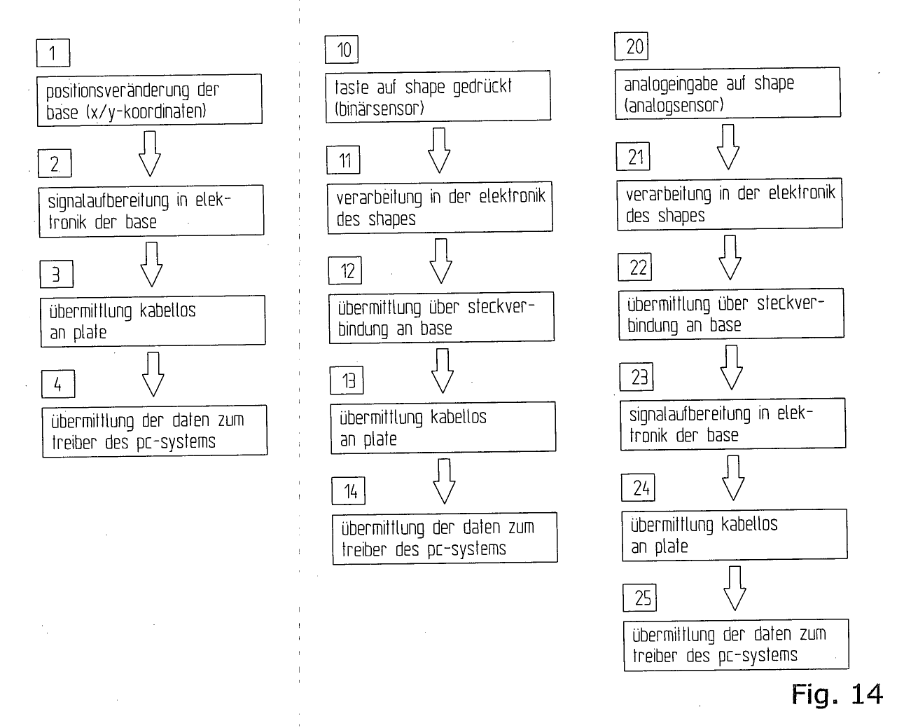

FIGS. 14 through 17 sequences of procedures for operating the interface according to the invention; and

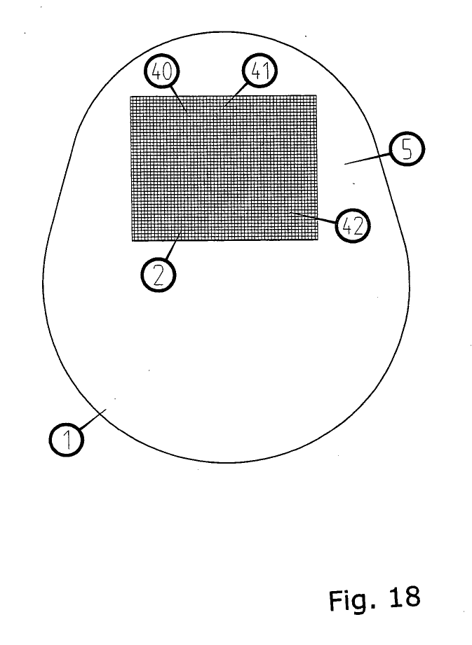

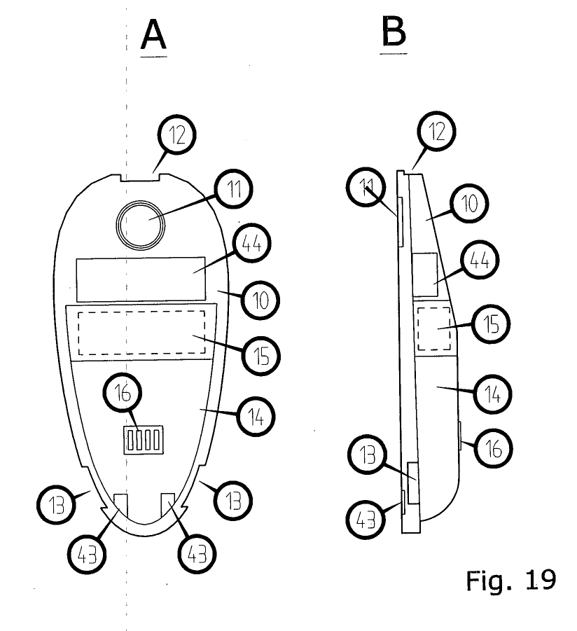

FIGS. 18 and 19 a digitizing tablet along with a matching interface.

FIG. 1 shows a digitizing tablet 1 (“plate”) according to the invention with a pointing region 2. This digitizing tablet 1 exhibits a connecting socket (“AUX”) for connecting external accessory devices to its front in order to connect additional accessory products to the system, which, like the base lower part, deliver digital and analog signals in order to forward them to the PC system. The sensitive region 2 is protected and identified by a flexible and transparent plastic film to allow the user to insert small masters. This receiving core can be implemented in such a way that it can be removed as a whole in order to carry out maintenance work or to insert masters. In that case, the flexible plastic film can be replaced by a rigid viewing window that is solidly mounted in the housing of the digitizing tablet.

The connection to the PC system is realized via a highly flexible plastic line 4 with kink protection. It can be a serial interface, a USB plug connection, or other interface to the computer.

In addition, this digitizing tablet contains evaluation electronics and send/receive units for connecting both to the PC system as well as to the lower part of the computer mouse. In this regard, the data transmission rate is chosen in such a way that total product reaction time, i.e., one piece of information to the PC system, in less than 50 ms is assured. The position detection of the magnetic grid is greater than 2000 lpi in the sensitive region 2.

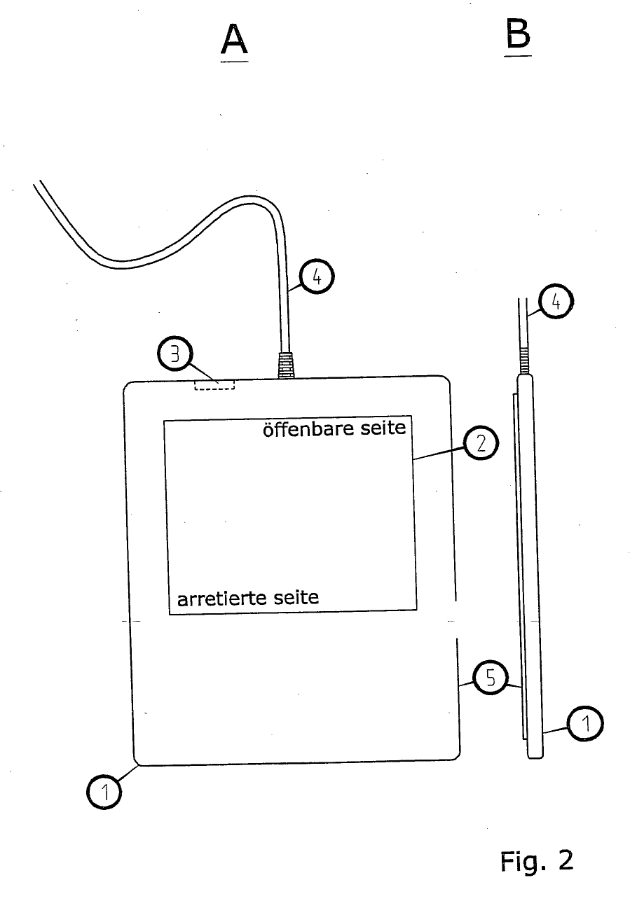

As can be seen in FIG. 1A and the associated side view of FIG. 1B, the digitizing tablet exhibits a contact area 5 for a computer mouse, whereby, however, only a small part is actually suitable as sensitive area 2 for position detection. A larger sensitive area is also not needed if, as in this example, a mouse is to be used with an associated part for position detection placed at its tip. FIGS. 2 through 4 show additional digitizing tablets with various external shapes as they can be used for various mouse shapes. Here and in the following, the same reference numbers will be used for the same elements in all of the figures.

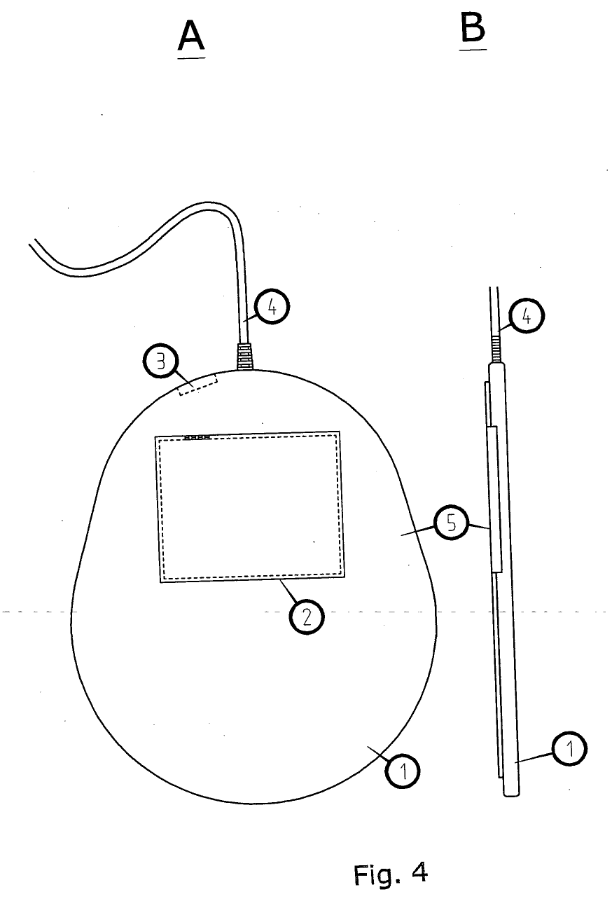

In the case of FIGS. 1 through 3, the sensitive region 2 is covered with a film that is easily placed recessed and ends flush with the mouse contact surface 5. In the case of FIG. 4, the sensitive region 2 (pointing region) is transparent and solidly mounted. This pointing area 2 is designed as a removable technical unit in order to be able to change the covers or to exchange the unit itself.

FIG. 5 shows a base part of an interface according to the invention in the form of a computer mouse. This base part 10 (“base”) is shown in FIG. 5A in a phantom view from above and in FIG. 5B in a phantom view from the side. The base part 10 serves as the carrier for the easily exchangeable upper parts (“shapes”). In conjunction with this, the software is implemented in such a way that an exchange of shapes is possible at any time during operation, and a change of shapes is detected by the PC system software and by the internal electronics of the digitizing tablet or the base part.

The base part 10 contains a device for position detection 11 in the form of an electromagnetic coil that simultaneously serves as send/receive unit for the digitizing tablet. It transmits data from the coordinates or the shape actions.

The associated electronics 14 are completely encapsulated. All that is visible of these electronics 14 are a connecting plug 16 to the shape and a battery/rechargeable battery slot 15.

In addition, this base 10 exhibits a latching mechanism 12 as well as two snap-in mechanisms 13, by means of which a shape can be securely locked with the base 10.

FIG. 6 now shows in both sub-pictures A and B a top phantom view and a side phantom view of an upper part 20 (“shape”) according to the invention. This shape 20 exhibits a total of 16 keys 17 as well as a connecting plug 22 by means of which the signals triggered by the keys 17 can be transmitted to the plug 16 in the base 10. In addition, the shape 20 possesses side keys or buttons 19 for inputting information. Corresponding to the latching and snap-in mechanisms 12 and 13 in FIG. 5, placed in the shape 20 are corresponding snap-in mechanisms 21, which cooperate with the mechanisms 12 and 13 of a base part 10 in such a way that they connect the shape detachably but securely with the base.

In addition, the shape 20 exhibits a quick-access button 18, which functions like a conventional key input, but has a fixed assignment to the program by means of which the computer mouse can be configured.

With the quick-access button 18, the administrative program for the computer mouse is immediately activated from any application. The user thus has the opportunity to change his application configuration quickly and easily at any time.

If the shape 20 is changed, it is detected by the hardware and software without restarting the operating system and programs that are running. The basis for this is, among other things, the fact that the input means, Such as keys 17 in the shape 20, are connected via evaluation electronics with the connector 22. These evaluation electronics convert the input signals from the input means, for example, the keys 17, into logical signals. These evaluation electronics are comprised of an integrated chip, which, for example, can process at least a minimum number of 20 digital and 6 analog input signals quasi-parallel in all shapes. Even if this amount of signals is not made available by the input means, with uniform evaluation electronics in all of the upper parts, the compatibility of all shapes with the associated base parts as well as the associated transmission protocols and software in the computer is assured.

Moreover, this chip advantageously can not only evaluate the input signals of the user, such as a keystroke or use of a wheel, it can also encode at the same time so that the data can be made available to the base part 10 already conditioned for the corresponding transmission protocol.

FIG. 6 shows an upper shell 20 that exhibits a total of 16 keys, as is suitable for CAD/CAM applications or for desktop publishing, for example.

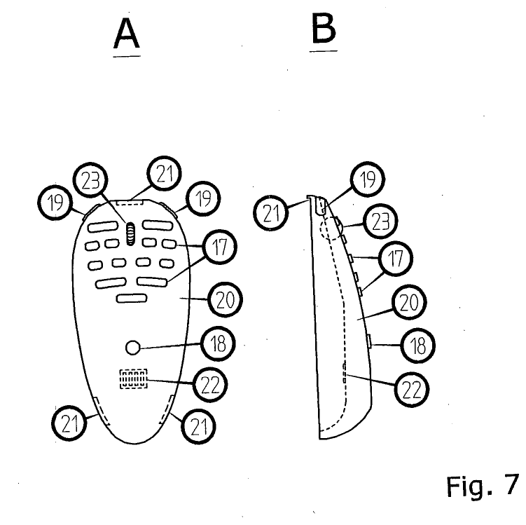

FIG. 7 shows an upper shell 20 with a total of 13 buttons 7 and two side buttons 19, as well as one wheel 23. A snap-on module 20 of this type is suitable for internet users, standard users and beginners, school children or students, due to the reduced number of keys and the simple input medium of the wheel 23.

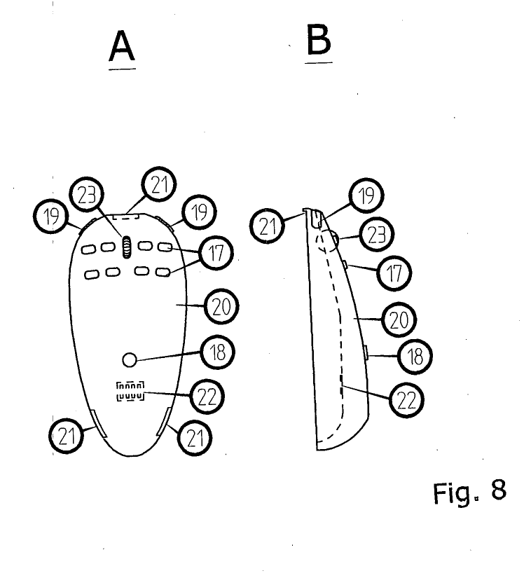

FIG. 8 shows an additional upper shell 20 on which only eight keys 17, two side keys 19 and one wheel 23 are provided. This snap-on module 20 is suitable for home use, gaming, or for occasional users.

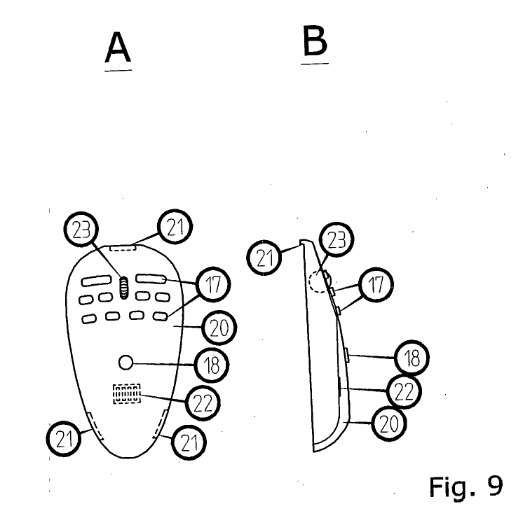

FIG. 9 shows an additional snap-on module 20, the external shape of which is strongly reduced in size. It exhibits eight keys 17 as well, no side keys 19, but one wheel 23. This reduced-size snap-on module 20 is especially well-suited for children's hands. If necessary, a reduced-size base part 10 can also be made available. However, it is not urgently required.

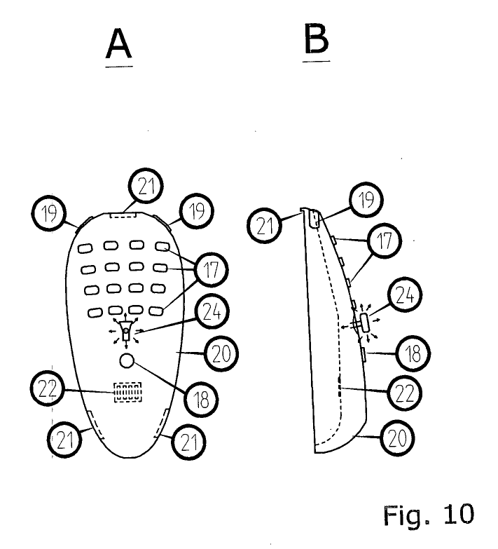

FIG. 10 shows an additional snap-on module 20 with a total of 16 keys 17, two side keys 19 and one analog stick 24 by means of which a total of six degrees of freedom can be input (three axes and three degrees of inclination). This snap-on module 20 is suitable for work in the 3D field.

FIG. 11 shows an additional base 10 with send/receive electronics 14, a battery compartment 15, a plug 16 and the latch mechanisms 12 and 13 as they are already known from FIG. 5 and described there. A coil 11 is also provided for position detection and as a send/receive device.

In addition to the base part 10 from FIG. 5, this base 10 exhibits a slot 26 for memory cards, along with evaluation electronics 27 for reading from and writing to these memory cards. In addition,

a headphone socket 25, by means of which headphones can be connected to the base 10, is connected to these evaluation electronics 27.

FIG. 12 shows the upper shell 20 that is associated with this, which exhibits openings 28 for the headphone socket and 31 for the memory card slot. Also shown in this representation is a memory card 30, which has just been inserted through the opening 31 and into the memory card slot 26 in the base part 10.

The snap-on module 20 additionally exhibits a display device 29 (display), as well as two keys 17 and a wheel 23. By using these input means 17 and 23, the evaluation electronics 27 can now be controlled in such a way that the memory card 30, which is located in the slot 26, can be read or written. In particular, this can involve a memory card 30 or another storage medium for audio files. Thus, it is also possible to provide an MD drive, cassette drive or CD drive as the slot 26. In that case, the audio file on the storage medium 30 can be listened to by means of headphones connected to the headphone connection 25. Thus, this is a computer mouse with an integrated music playback device, e.g., with an integrated MP3 player.

It is advantageous in this regard if the latching mechanism 19, 21 and the positioning functionalities as a cursor are available in parallel with the playback operation, so that work with the computer can continue along with the playing back of the music.

The electronics of the base unit are configured in such a way that direct transmission from computer mouse to computer mouse is possible by means of the position and transmission unit 11. Exchange of data from mouse to mouse is possible with control commands via the display 29.

FIG. 13 shows a digitizing tablet 1 in cooperation with an interface according to the invention consisting of a base part 10 and upper shell 20. Also here is the digitizing tablet known from FIG. 1, as well as the base parts and upper parts known from FIGS. 5 and 6. It can be seen that only the coil 11 always has to stay within the sensitive region 2 in order to make position recording and data transmission possible. The region of the digitizing tablet 1 that lies outside of the sensitive region 2 is used only for the mechanical guidance of the computer mouse and as a hand rest.

FIGS. 14 through 17 show the course of various processes and data evaluations in the computer mouse and in the digitizing tablet. Shown in FIG. 14 is the way in which a change in position of the base part, which is recorded in the base part, is conditioned in the base part and transmitted to the digitizing tablet wirelessly. From there, the data are transmitted from the digitizing tablet to the computer via line 4.

Shown in steps 10 through 14 is the way in which an input on the upper shell 20, the pressing of a key, for example, is recorded and is then evaluated while still in the upper shell 20 by the electronics provided there. This evaluated signal pertaining to the push of the key is subsequently transmitted via the plug-and-socket connection 16, 22 to the lower part 10, which then transfers it via the coil 11 to the digitizing tablet. Form there, the information regarding the key stroke is in turn transmitted to the computer.

Shown in steps 20 through 25 is the way in which an analog input, e.g., from a 3D stick or a wheel or a trackball, in the upper part 20 generates signals and is forwarded. Again, the processing of these analog signals still takes place directly in the upper part 20, and is transmitted to the lower part 10 via the plug-and-socket connection 16, 22. In this case, additional signal conditioning takes place in the lower part in step 23.

The evaluation unit located in the upper part 10 simplifies the signals coming from the analog and digital input units such as sticks, trackballs and keys, and delivers to the base unit in the lower part 20 a defined data protocol that contains the type of shape (shape ID) and the states of the keys and the analog input units.

Transmission to the digitizing tablet and the PC system then takes place in the known way.

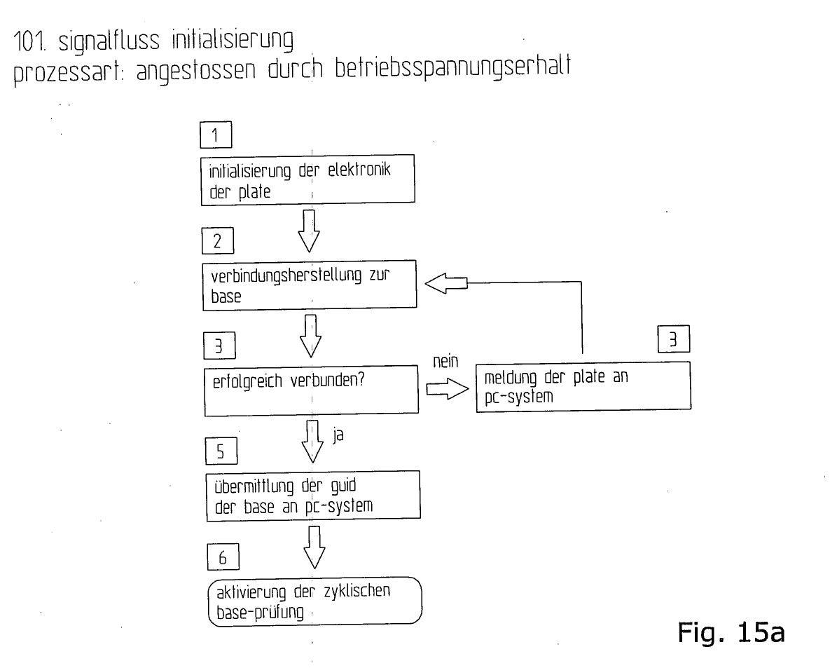

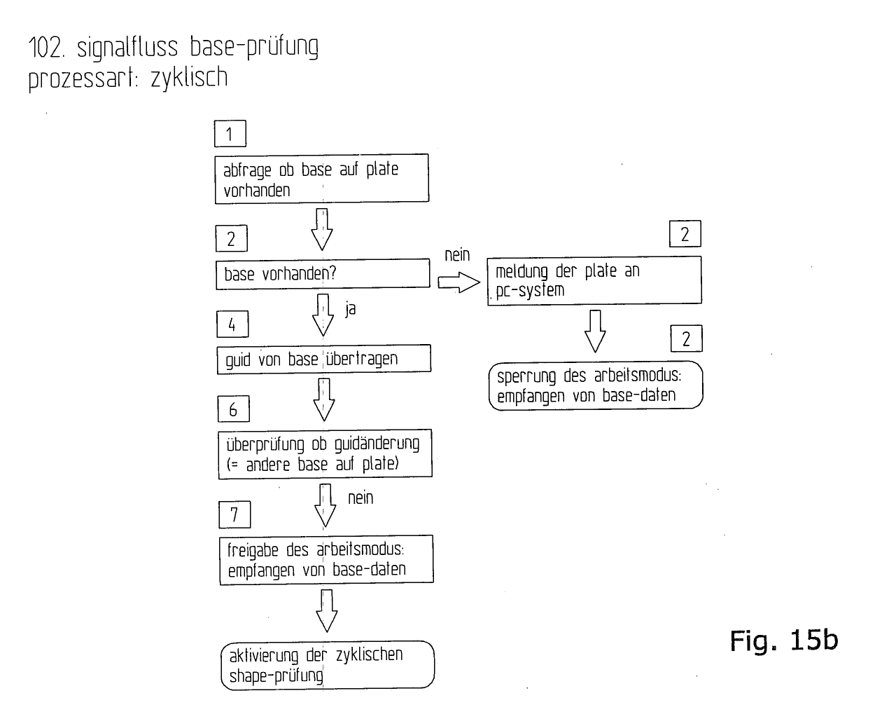

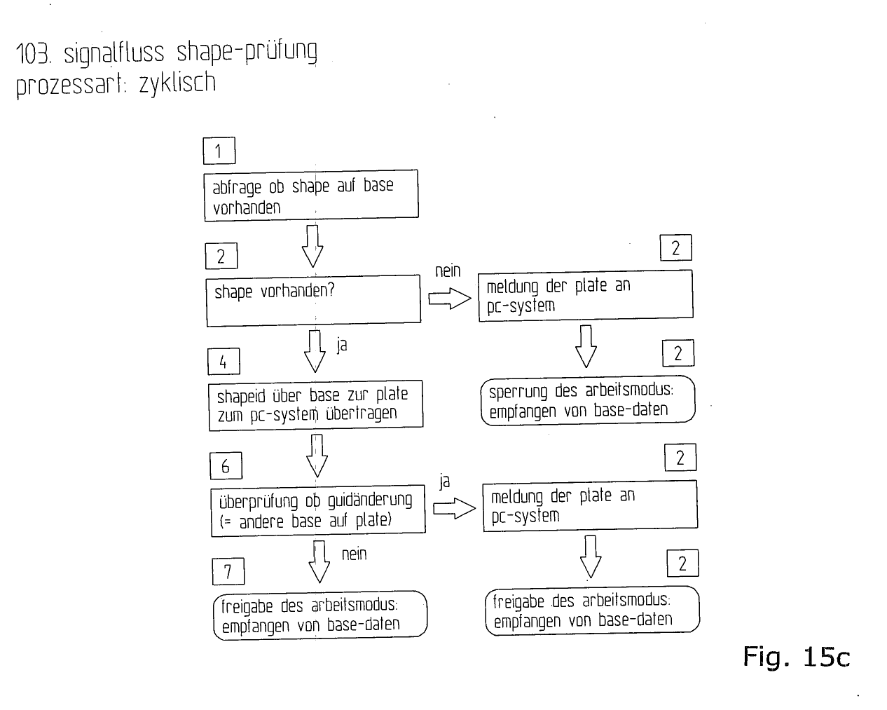

FIG. 15 shows the beginning of the operation of the system according to the invention. Once the electronics of the digitizing tablet has been initialized through application of a voltage, it establishes a connection to the lower part. After the connection between the digitizing tablet and the lower part has successfully been established, a Global Unique Identifier (GUID) of the lower part is sent as identification via the digitizing tablet to the PC. With that, the computer begins a cyclical test of the presence of the lower part. This test is shown in FIG. 15 under item 102. This means that at this point it is cyclically asked if a lower part is present and what Global Unique Identifier (GUID) this lower part possesses. If the Global Unique Identifier changes, the computer automatically recognizes that the lower part has been exchanged. Thus, it is possible, for example, to block the computer if another user attempts to access it by using a different lower part. The lower part itself can thus act as an access control, whereby the use of the correct lower part allows access to the computer.

In the same way, the computer can be blocked if the lower part is removed and no lower part is present.

Shown in FIG. 15 under item 103 is the way in which the upper part is cyclically interrogated. That way, the computer can be blocked if no upper part is present on the lower part, or the computer can be blocked if an incorrect upper part is sitting on the lower part.

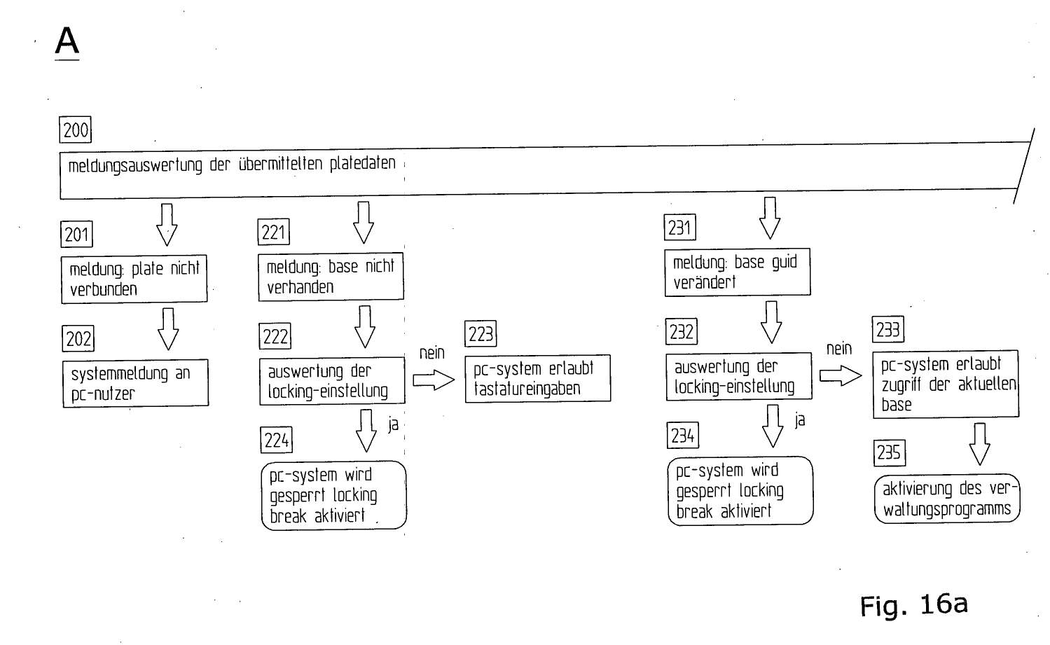

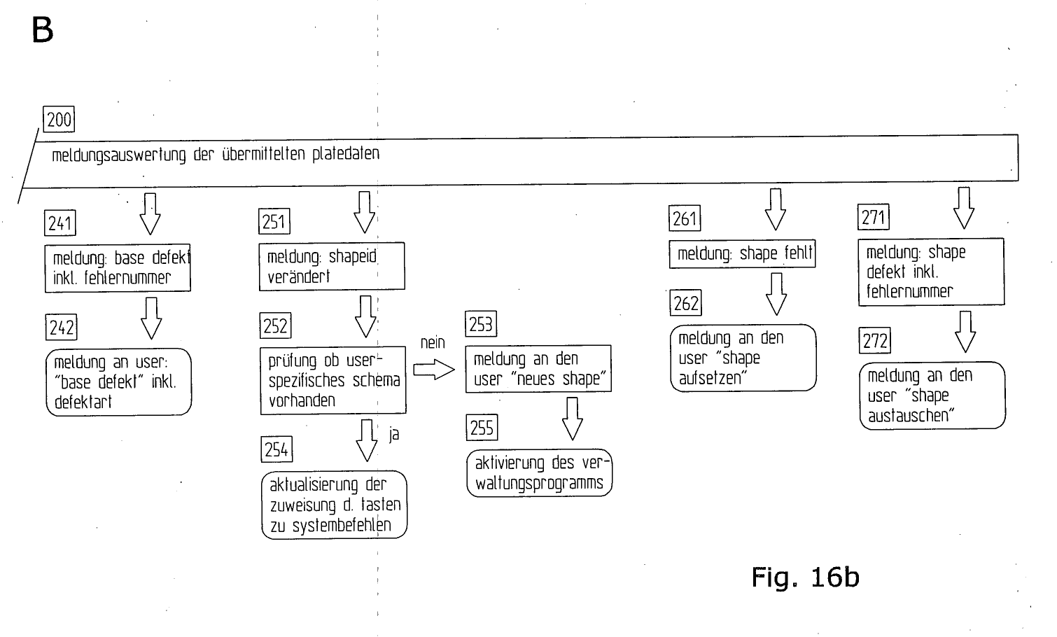

FIG. 16 shows, in FIG. 16A, the way in which the computer is cyclically interrogated as to whether a digitizing tablet is connected to it, whether a lower part is resting on this digitizing tablet, and which Global Unique Identifier this lower part possesses. In this way, the computer can be blocked if no digitizing tablet is present or if a lower part is no longer present, or if the Global Unique Identifier of the lower part is incorrect and a regular login, e.g., via the keyboard, was not made.

Shown in FIG. 16B is the evaluation of the cyclical interrogations that conveys to the computer an error in the lower part, a change of the upper part, a lack of an upper part or a defect in the upper part. Here again, a situation-specific blocking of the computer, an updating of the usage properties, or something similar can take place. In particular, as is shown in step 254, the allocation of the keys to system commands, i.e., the menu assignments of the input means of the computer mouse, can be updated if the upper part has been changed and the computer consequently detects this changed upper part, for example, by means of a code word (“shape ID”) stored in the upper part and transmitted to the computer upon interrogation. In a similar way, the user can obtain guidance from the computer if the computer detects that the upper part is either missing or defective. In that case, the user is informed in step 262 that an upper part should be placed on the lower part, or is informed in step 272 that the upper part should be exchanged for an upper part that is not defective.

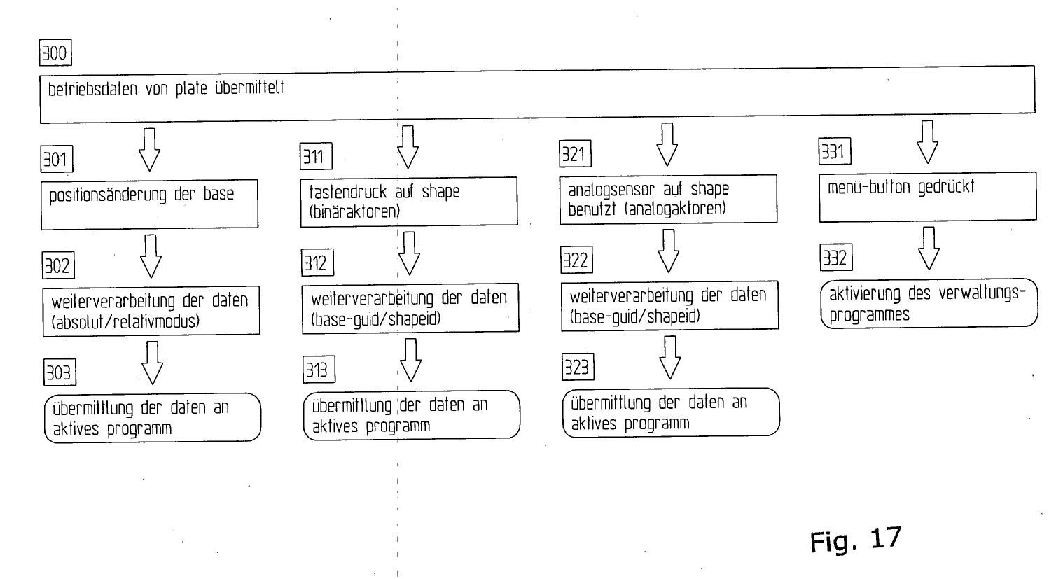

FIG. 17 shows the processing of data that are collected and transmitted by the computer mouse. These data are position changes that are recorded by the lower part, or inputs such as a keystroke or analog inputs that have been generated on the upper part.

The menu button in step 331 in FIG. 17 is, for example, the quick-access button 18 per FIG. 6.

FIG. 18 shows another digitizing tablet 1, whereby the same reference numbers are used for the same elements, and for that reason they will not be explained any further. This digitizing tablet 1 exhibits a pointing region 2 that has a ferromagnetic grid 40. Such a digitizing tablet can be used for position detection by means of coil scanning. The flexible, molded-in permanent magnet grid mat 2 provides a reference magnetic field in the milliTesla range that can be tapped by means of Hall sensors or else by means of one or more coils in the base body of the interface. For orientation and positioning in absolute form, a stronger reference line for the x-axis, with reference number 41, and for the y-axis, with reference number 42, are incorporated in the magnetic grid 40 in the recording region 2. A digitizing tablet 1 of this type can be made of a flexible material, for example, and contains no electronic components itself. Position recording takes place only inside the interface.

FIG. 19 shows an interface 19 suitable for scanning the position of a digitizing tablet per FIG. 18. Here again, the same reference numbers are used for the same elements, so they will not be described again.

In an enhancement of the interfaces shown above, this interface exhibits a send and receive unit 44 that undertakes the direct communication with the computer system or other devices. It transmits the data of the position recorded through the coil 11 and of the keypad of the interface from the electronic unit 14 to the computer system or the other devices. They can be conditioned in advance and transmitted only thereafter. The send/receive unit 44 is based on Bluetooth technology, by means of which devices can exchange standardized data.

This interface also exhibits a rechargeable battery 15 that can be charged via the sockets 43 in the lower part of the interface. By means of a suitably designed charging station, which can be a storage location at the same time, the charging and the transmission of the charging energy to the rechargeable battery 15 can take place during the rest periods between work phases.

With the interface per FIG. 15, the position recording takes place via coil scanning, by means of a coil 11, of the magnetic field generated by the flexible, molded-in permanent magnet grid mat 40 of FIG. 18. With the interface according to the invention, however, an electrically generated magnetic field can also be scanned. It is thus possible to perform he position recording by means of the interface, and to send to the computer or another device preconditioned position data and input data from the keypad of the interface.

By way of summary, it can be said that through the present invention an interface is made available that makes possible an inexpensive, simple, and extremely rapid adaptation of the interface to various users and various applications. In addition, an interface of this type allows it to be used for controlling access to computers. Additional functionalities are used for the temporary storing of data, which are thus easily transportable. This also applies for the added function of an audio player, which makes this interface into a multifunctional, user-specific article. the base part (10) and the upper part (20) are connected to each other.

2. Interface according to the preceding claim, characterized in that the connection elements are plugs (22) and sockets (16) of an electrical plug-and-socket connection.

3. Interface according to one of the preceding claims, characterized in that the input element is connected to the second connection element via an electronic conversion device, mounted in or on the upper part (20), for evaluating, converting and/or encoding the input signals into digital input signals.

4. Interface according to one of the preceding claims, characterized in that the upper part (20) exhibits as input devices keys (17), keypads, in particular, keypads with two, three or six keys, rotary knobs, wheels (23), trackballs, sticks, 3D sticks (24), detents, controllers or similar things.

5. Interface according to one of the preceding claims, characterized in that the upper part (20) exhibits a display (29) on its outside.

6. Interface according to one of the preceding claims, characterized in that the transmission device exhibits a send and/or receive device (11) for sending and/or receiving data signals.

7. Interface according to one of the preceding claims, characterized in that the send and/or receive device exhibits a coil (11) with which signals can be sent and/or received.

8. Interface according to one of the preceding claims, characterized in that the position of the housing (10, 20) can be recorded by means of a coil (11).

9. Interface according to one of the preceding claims, characterized in that the position of the housing (10, 20) can be recorded by means of the coil (11) of the send and/or receive unit.

10. Interface according to one of the preceding claims, characterized in that the base part (10) exhibits a memory device for digital data and/or a receptacle (26), for a memory device of such a type, which is connected to the transmission device (11).

11. Interface according to one of the preceding claims, characterized in that the memory device is a memory chip (RAM, ROM, EPROM) or something similar.

12. Interface according to claim 10, characterized in that the receptacle device (26) is a slot, for example, for a flashcard.

13. Interface according to one of the three preceding claims, characterized in that one or more assignment menus, for example, software-specific assignment menus, for the input elements of the interface, passwords, identifiers, for example, access identifiers or codes, or similar things can be stored in the memory device.

14. Interface according to one of the four preceding claims, characterized in that information from a computer can be temporarily stored in the memory device (26).

15. Interface according to one of the preceding claims, characterized in that the base part exhibits a battery compartment (15), a rechargeable battery compartment, a battery, a rechargeable battery and/or a battery backup for supplying the electrical components of the interface with electric current.

16. Interface according to one of the preceding claims, characterized in that the base part exhibits a rewriteable audio memory for audio files or a receptacle (26) for an audio memory of that type, for example, a slot for a flashcard (30) or something similar, which can be operated via the input elements.

17. Interface according to the preceding claim, characterized in that the base part exhibits a connection (25) for headphones, which is connected to the audio memory (30) for audio files or the receptacle (26) for an audio memory in such a way that the sounds stored in an audio memory (30) as audio files can be sent to the headphone connection (25) in a form suitable for headphone playback.

18. Interface according to the preceding claim, characterized in that the memory (30) for audio files or the slot (26) are connected to the headphone connection (25) via an audio data evaluation device (27).

19. Interface according to one of the preceding claims, characterized in that the base part (10) can be snapped into place with the upper part (20).

20. Interface according to one of the preceding claims, characterized in that placed in or on the upper part (20) is a detaching device for detaching the connection between the upper part (20) and the base part (10).

21. Interface according to one of the two preceding claims, characterized in that the detaching device exhibits an unlatching mechanism, for example, a release button, which triggers an unsnapping mechanism.

22. Use of a device according to one of the preceding claims for controlling a computer.

23. Use of a device according to one of the preceding claims 1 through 21 for inputting control commands or characters into a computer, for controlling a cursor, for storing predetermined or user-defined assignment menus of a software program, for storing digital data, for controlling access control to a computer and/or for playing back and/or recording audio files.
